(19) United States
(12) Patent Application Publication
(10) Pub. No.: US 2009/0291163 A1
(43) Pub. Date: Nov. 26, 2009

(54) MILK-BASED RECOVERY BEVERAGE

(75) Inventors: Kimberly White, Arlington Heights, IL (US); Jeff Zachwieja, Cary, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Stokely-Van Camp, Inc., Chicago, IL (US)

(21) Appl. No.: 12/469,378

(22) Filed: May 20, 2009

Related U.S. Application Data
(60) Provisional application No. 61/055,021, filed on May 21, 2008.

(51) Int. Cl. A23J 1/20; A23L 1/303; A23G 4/14; A23L 2/66; A23L 1/305; A23L 2/02; A23F 3/14; A23F 5/36; A23L 2/395

(52) U.S. Cl. 426/3; 426/73; 426/66

(57) ABSTRACT

The applicants have discovered that consuming milk-based protein, carbohydrate, Vitamin D, calcium, and CLA in combination and in the relative concentrations disclosed herein results in a beneficial synergistic impact on body composition. It is believed that each component is directly or indirectly utilized in metabolic pathways which alter body composition in beneficial ways that would not be realized if one or more of the components were delivered separately and/or in concentrations other than those disclosed herein. Conventional food and beverages do not deliver the combination of these components in concentrations that maximize the synergistic potential. In certain exemplary embodiments, the composition described herein delivers, per 8 ounce serving, about 5 to 20 grams of milk-protein, about 5 to 26 grams of carbohydrate, about 98 to 1000 IU of Vitamin D, about 350-600 mg of calcium, and about 0.5 to 5 grams of conjugated linoleic acid to a consumer.

### RELATED APPLICATION

This application claims the benefit of U.S. Provisional Application Ser. No. 61/055,021 filed on May 21, 2008, which is incorporated in its entirety into the present application fully by reference and made part thereof.

### FIELD OF THE INVENTION

The present invention relates generally to edible compositions. More specifically, aspects of the invention relate to food and beverage products which utilize components of milk to impact body composition and aid in the recovery from endurance and resistance exercise.

### BACKGROUND

Improved and new food and beverage formulations are desirable to meet changing market demands. In particular, there is perceived market demand for food and beverages that impact body composition and aid in the recovery from endurance and resistance exercise. Also, there is perceived market demand for food and beverages having alternative flavor profiles, including good taste, mouthfeel, etc. In addition, there is consumer interest in food, beverages, and other beverage products, such as beverage concentrates, etc. whose formulations make greater use of natural ingredients, that is, ingredients distilled, extracted, concentrated or similarly obtained from cow's milk, harvested plants, and other naturally occurring sources, with limited or no further processing.

The development of new food and beverage formulations, for example, new food and beverage formulations incorporating milk or components of milk, presents challenges in addressing disadvantages associated with milk, such as disagreeable taste, lactose intolerance (and other non-desirable sensitivities associated with milk), and non-optimized concentrations of beneficial components. In addition, such challenges typically are presented in new food and beverage formulations that incorporate milk or components of milk developed for use during or after sports activity. There is a need for new food and beverage formulations which can satisfactorily meet the combination of objectives including having optimized concentrations of beneficial milk components, agreeable taste, increased tolerability to those with sensitivities to milk, and other objectives.

It is an object of the present invention to provide food, beverages, and other beverage products. It is an object of at least certain embodiments of the invention (that is, not necessarily all embodiments of the invention) to provide food, beverages, and other beverage products that incorporate components of milk that can impact body composition and/or aid recovery from exercise having optimized concentrations of such components and desirable taste properties. It is an object of at least certain (but not necessarily all) embodiments of the invention to provide food, beverages, and other beverage products having improved formulations. It is an object of at least certain (but not necessarily all) embodiments of the invention to provide food and beverage products having formulations tolerable to individuals with sensitivities to milk. These and other objects, features and advantages of the invention or of certain embodiments of the invention will be apparent to those skilled in the art from the following disclosure and description of exemplary embodiments.

### DETAILED DESCRIPTION

Those of ordinary skill in the art will understand that, for convenience, some ingredients are described here in certain cases by reference to the original form of the ingredient in which it is added to the beverage product formulation. Such original form may differ from the form in which the ingredient is found in the finished beverage product. Thus, for example, in certain exemplary embodiments of the beverage products according to this disclosure, different sweeteners can be substantially homogenously dissolved and dispersed in the beverage. Likewise, other ingredients identified as a solid, concentrate (e.g., juice concentrate), etc. would typically be homogenously dispersed throughout the beverage or throughout the beverage concentrate, rather than remaining in their original form. Thus, reference to the form of an ingredient of a beverage product formulation should not be taken as a limitation on the form of the ingredient in the beverage product, but rather as a convenient means of describing the ingredient as an isolated component of the product formulation.

It should be understood that food and beverage products in accordance with this disclosure may have any of numerous different specific formulations or constitutions. The formulation of a food or beverage product in accordance with this disclosure can vary to a certain extent, depending upon such factors as the product's intended market segment, its desired nutritional characteristics, flavor profile, recommended FDA dosage, and the like. For example, it will generally be an option to add further ingredients to the formulation of a particular beverage embodiment, including any of the beverage formulations described below. Additional (i.e., more and/or other) sweeteners may be added, flavorings, electrolytes, vitamins, fruit juices or other fruit products, tastants, masking agents and the like, flavor enhancers, and/or carbonation typically can be added to any such formulations to vary the taste, mouthfeel, nutritional characteristics, etc.

In general, a food or beverage composition in accordance with this disclosure typically comprises at least milk-based protein, carbohydrate, Vitamin D, calcium, and conjugated linoleic acid (CLA). As will be readily appreciated by those skilled in the art upon review of the following, the amount of these components present among different embodiments will depend on a myriad of factors, including but not limited to: the targeted amount of milk-based protein, carbohydrate, Vitamin D, calcium, and conjugated linoleic acid to deliver to the consumer, the type of food or beverage (i.e., a bar, a sports drink, a diet beverage, a smoothie or a shake), special considerations for packaging and shipping, and/or specific ingredients in the composition.

The milk-based protein can be a blend of whey and casein. It has been found that whey and casein are high quality milk-based proteins that stimulate muscle growth when consumed during strength training. In certain exemplary embodiments, it may be desirable to deliver about 5 to 20 grams of milk-protein to a consumer, which is about 2.01 to about 7.78 wt % of milk-protein per 8 ounce serving. An amount of 10 grams of milk-protein is approximately equivalent to the amount found in two 8 oz. servings of milk. The targeted range of milk-based protein may depend on a myriad of factors, such as for example, metabolism, body chemistry, body size, gender, total daily protein consumption, type of exercise and/or the amount of physical activity. For example, a beverage composition formulated for a professional athlete undergoing strenuous strength training may comprise a different concentration of milk-protein than a beverage formulated for a recreational consumer who undergoes light exercise. In addition, in certain exemplary embodiment, soy protein can be used in place of milk-based protein, which is generally isolated from cow's milk.

The composition includes carbohydrate to, in part, stimulate protein uptake into the muscle and replace carbohydrate used during exercise. In certain exemplary embodiments, it may be desirable to deliver about 5 to 26 grams of carbohydrate to a consumer, which is about 2.01 to about 11.02 wt % of carbohydrate per 8 ounce serving. An amount of about 26 grams of carbohydrate is approximately equivalent to the amount of carbohydrate found in two 8 oz. servings of milk. The targeted range of carbohydrate may depend on a myriad of factors, such as, for example, body size, type of exercise performed, and how much milk-based protein is delivered to a consumer. The carbohydrate source may comprise complex carbohydrates, simple sugars, and combinations thereof. For example, the carbohydrate source(s) may comprise sucrose, high fructose corn syrup (HFCS), isomaltulose, dextrose, malodextrin, and/or mixtures thereof. Carbohydrate content can vary generally from about 4% to about 10% for a beverage product, but this range can be extended for other products, such as sports bars and other food products. In addition, the primary carbohydrate found in milk, lactose, may be specifically excluded from the composition to the benefit of consumers who are lactose intolerant.

The composition further includes Vitamin D, which has been shown to play a role in muscle protein synthesis. Vitamin D receptors are found in the muscle cell. When Vitamin D interacts with these receptors, it can initiate the process to generate new proteins. Vitamin D supplementation has been found to increase muscle mass in older adults without strength training. In certain exemplary embodiments, it may be desirable to deliver about 98 to 1000 IU of Vitamin D to a consumer. An amount of 200 IU is approximately equal to the amount of Vitamin D found in two 8 oz. servings of fortified milk. The recommended daily amount of Vitamin D is set by the FDA, such as 200 IU/day for adults under 50 years old, and 400 IU/day for adults after reaching 50 years old. It may be desirable to deliver higher amounts of Vitamin D to a consumer than what is currently recommended by the FDA. The desirable amount may vary according to gender, age, activity level, and other factors.

The composition further includes calcium. Adequate calcium consumption is necessary to optimize the function of Vitamin D. In addition, calcium has been shown to improve fat metabolism which may possibly improve loss of body fat with strength training. In certain exemplary embodiments, it may be desirable to deliver about 350-600 mg of calcium to a consumer, which is about 0.015 to about 0.50 wt % of calcium per 8 ounce serving. However, to maximize absorption, no more than about 600 mg of calcium should be consumed at one time. An 8 oz. serving of milk provides about 300 mg of calcium. The recommended daily amount of calcium is set by the FDA, such as 1,000 mg/day for adults. It may be desirable to deliver higher amounts of calcium to certain individuals, such as 1,200 mg/day for children and older adults. The desirable amount to deliver to individuals may also be based on gender and other factors. For example, in one exemplary embodiment, a single serving of the product, regardless of type of product, can deliver at least about 300 mg of calcium to a consumer. In another exemplary embodiment, a single serving of the product, regardless of type of product, can deliver no more than about 600 mg of calcium to a consumer.

The composition also includes conjugated linoleic acid. Conjugated linoleic acid has been found to increase muscle mass and decrease body fat in both sedentary individuals and athletes undergoing strength training. In certain exemplary embodiments, it may be desirable to deliver about 0.5 to 5 grams of conjugated linoleic acid to a consumer, which is about 021 to about 2.07 wt % of conjugated linoleic acid per 8 ounce serving. In addition, in other exemplary embodiments, conjugated linoleic acid can be substantially the only fatty acid in the composition, meaning that the concentration of other fatty acids in the composition is negligible. Conjugated linoleic acid is found in only small amounts naturally in milk, i.e., about 5 mg for every gram of fat in the milk or 0.03 g in an 8 oz. serving of whole milk.

The applicants have discovered that consuming milk-based protein, carbohydrate, Vitamin D, calcium, and CLA in combination and in the relative concentrations disclosed herein results in a beneficial synergistic impact on body composition. It is believed that each component is directly or indirectly utilized in metabolic pathways which alter body composition in beneficial ways that would not be realized if one or more of the components were delivered separately and/or in concentrations other than those disclosed herein. Conventional food and beverages do not deliver the combination of these components in concentrations that maximize the synergistic potential. The food and beverage product formulations disclosed herein provide milk-based protein, carbohydrate, Vitamin D, calcium, and CLA in combination and in optimized relative concentrations to maximize the beneficial synergistic impact on the body. In addition, when the optimized concentrations of these components are combined with other ingredients disclosed herein, such as for example electrolytes, further beneficial impacts on the body can be realized.

Other ingredients may be present in the beverage composition, such as electrolyte sources. Providing one or more electrolytes aid in, for example, fluid adsorption in the small intestines and helps to maintain osmotic balance in the body. Electrolyte enhanced beverages are particularly useful for rehydrating the body during, for example, heightened physical activities.

In certain exemplary embodiments, the beverage composition includes an electrolyte source for providing sodium (Na). Sodium may be provided by compounds of sodium, such as sodium chloride, sodium citrate, sodium carbonate, sodium bicarbonate, or combinations thereof. In select embodiments, the amount of sodium is about 0.03 to about 0.06 wt % of the beverage. Other amounts may also be useful, depending on the application and other factors. In one embodiment, the sodium is provided by sodium chloride and sodium citrate.

Additional types of electrolyte sources to provide, for example, potassium (K), magnesium (Mg), and chloride (Cl) ions can also be included in the beverage composition in addition to or independently of sodium (Na). The different types of electrolytes can be provided by their compounds or a combination of their compounds. For example, the compounds can include potassium acetate, potassium bicarbonate, potassium bromide, potassium chloride, potassium citrate, potassium-D-gluconate, mono- and dibasic potassium phosphate, calcium chloride, magnesium chloride, magnesium carbonate and magnesium sulphate, or a combination thereof. In one embodiment, the potassium ions may be provided by monopotassium phosphate or dipotassium phosphate. In one such embodiment, monopotassium phosphate may comprise around about 0.0439 wt % of the beverage composition. In another embodiment, the beverage may contain about 0.01 to about 0.04 wt % of potassium, about 0.01 to about 0.02 wt % of magnesium, about 0.02 to about 0.03 wt % of chloride. Other amounts or combinations may also be useful.

Non-mineral nutritive compounds such as vitamins can be added to the beverage composition. Vitamins such as Vitamin A, Vitamin B, Vitamin C, and Vitamin E may be provided in various embodiments. The beverage composition can also include a pH adjuster, for example, citric acid. Other types of pH adjusters or a combination of pH adjusters may also be present in various embodiments prepared in accordance with the invention. The pH of certain beverage compositions may be formulated to be generally at about 2.0 to about 4.0. Such pH levels may be desirable for a variety of formulations, such as for example, a “non-shake” type beverage. The pH range for a “shake” type beverage (for example, such as one containing milk-based ingredients such as milk protein) according to select embodiments, may generally have a higher pH. Other types of beverage products.(i.e., ready to drink liquid formulations, beverage concentrates and the like) disclosed here include, e.g., carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sport drinks, and alcoholic products.

Water may be the vehicle or liquid portion in which ingredients are dissolved, emulsified, suspended or dispersed. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain typical embodiments, water is present at a level of from about 80% to about 99.9% by weight of the beverage. In at least certain exemplary embodiments the water used in beverages and concentrates can be “treated water,” which refers to water that has been treated to remove substantially all mineral content of the water prior to optional supplementation, e.g., with calcium.

Additional ingredients may be used in the beverage (or non-beverage) formulation, according to the teaching of this invention, include tart fruit juices, such as cherry juice. Non-limiting additional examples of other useful juices include natural juices such as orange juice, grape juice, pineapple juice, lemon juice and lime juice. The percentage of juice may vary, and several different juices may be added to a formulation. According to certain embodiments, a portion or all of the water in a formulation may be replaced with fruit juice. In non-beverage embodiments, powdered juices or juice concentrates can be added. Some alteration of acidic ingredients in a formulation may be recommended for sensory purposes when fruit juices are used, but such alterations are be within the skill of a person with experience as a formulator.

In another embodiment, a beverage concentrate may be packaged as gels, capsules, or tablets which are consumed with liquid. When provided in these forms, the beverage composition may comprise instructions to mix or consume with an amount of liquid which is equal to about 80-99 wt % of the prepared beverage composition. Additionally, non-beverage type products can be formulated based on the guidance given herein and are within the scope of this disclosure. Such other product forms may include, but are not limited to, sports or performance bars, sports or performance gels, chewing gum, sublingual strips, gummy-based products, and confectionery type products. These are merely exemplary of other product forms and will be within the skill of a product formulator when considered together with the teachings provided herein.

In addition, in one exemplary embodiment, the optimized relative concentration of components in the formulation disclosed herein may be optimized relative to the recommended dosage of one or more components as determined by the FDA. If the FDA recommended dosage for one or more components change, the relative concentration of those and other components in the formulation may be modified accordingly to reach optimized levels. Such modification of the formula according to changes in FDA recommended dosage values will be within the skill of a product formulator when considered together with the teachings provided herein.

What is claimed is:

1. A food product composition comprising, per 8 ounce serving:
(a) 5 to 20 grams of milk-protein;
(b) 5 to 26 grams of carbohydrate;
(c) 98 to 1000 IU of Vitamin D;
(d) 350-1200 mg of calcium; and
(e) 0.5 to 5 grams of conjugated linoleic acid.

2. The food product composition of claim 1 wherein the milk-protein comprises at least one of whey, casein, and mixtures thereof.

3. The food product composition of claim 1 wherein the carbohydrate comprises at least one of high fructose corn syrup, isomaltulose, dextrose, malodextrin, and mixtures thereof.

4. The food product composition of claim 1 further comprising an electrolyte source.

5. The food product composition of claim 4 wherein the electrolyte source comprises at least one of sodium chloride, sodium citrate, sodium carbonate, sodium bicarbonate, potassium acetate, potassium bicarbonate, potassium bromide, potassium chloride, potassium citrate, potassium-D-gluconate, mono potassium phosphate, dibasic potassium phosphate, calcium chloride, magnesium chloride, magnesium carbonate, magnesium sulphate, monopotassium phosphate, dipotassium phosphate, and mixtures thereof.

6. The food product composition of claim 1 further comprising a vitamin of at least one of Vitamin A, Vitamin B, Vitamin C, and Vitamin E, and mixtures thereof.

7. The food product composition of claim 1 further comprising a pH adjuster.

8. The food product composition of claim 7 wherein the pH of the composition is about 2.0 to 4.0.

9. The food product composition of claim 1 wherein the food product comprises a beverage.

10. The food product composition of claim 9 wherein the beverage comprises at least one of a carbonated soft drink, non-carbonated soft drink, fountain beverage, frozen ready-to-drink beverage, coffee beverage, tea beverage, dairy beverage, powdered soft drink, liquid concentrate, flavored water, enhanced water, fruit juice, fruit-juice flavored drink, sports drink, and alcoholic beverage.

11. The food product composition of claim 1 further comprising water, wherein the water is about 80 to about 99.9 wt % of the composition.

12. The food product composition of claim 1 wherein the conjugated linoleic acid is substantially the only fatty acid in the composition.

13. The food product composition of claim 1 wherein the food product comprises at least one of a gel, tablet, performance bar, chewing gum, sublingual strip, gummy-based product, and confectionary.

14. A beverage comprising, per 8 ounce serving:
(a) about 2.01 to about 7.78 wt % of milk-protein;
(b) about 2.01 to about 11.02 wt % of carbohydrate;
(c) about 98 to about 1000 IU of Vitamin D;
(d) about 0.15 to about 0.50 wt % of calcium; and
(e) about 0.21 to about 2.07 wt % of conjugated linoleic acid.

15. The beverage of claim 14 further comprising an electrolyte source for providing at least one of sodium, potassium, magnesium, chloride, and mixtures thereof.

16. The beverage of claim 15 wherein at least one of the sodium is about 0.03 to about 0.06 wt % of the beverage, the potassium is about 0.01 to about 0.0439 wt % of the beverage, the magnesium is about 0.01 to about 0.02 wt % of the beverage, and the chloride is about 0.02 to about 0.03 wt % of the beverage.

17. The beverage of claim 15 wherein the electrolyte source comprises at least one of sodium chloride, sodium citrate, sodium carbonate, sodium bicarbonate, potassium acetate, potassium bicarbonate, potassium bromide, potassium chloride, potassium citrate, potassium-D-gluconate, mono potassium phosphate, dibasic potassium phosphate, calcium chloride, magnesium chloride, magnesium carbonate, magnesium sulphate, monopotassium phosphate, dipotassium phosphate, and mixtures thereof.

18. The beverage of claim 14 further comprising water, wherein the water is about 80 to 99.9 wt % of the beverage.

19. The beverage of claim 14 wherein the milk-protein comprises at least one of whey, casein, and mixtures thereof.

20. The beverage of claim 14 wherein the carbohydrate comprises at least one of high fructose corn syrup, isomaltulose, dextrose, malodextrin, and mixtures thereof.

21. The beverage of claim 14 wherein the carbohydrate is about 0.10 to about 10 wt % of the beverage.

22. The beverage of claim 14 further comprising a vitamin of at least one of Vitamin A, Vitamin B, Vitamin C, Vitamin E, and mixtures thereof.

23. The beverage of claim 14 further comprising a pH adjuster.

24. The beverage of claim 23 wherein the pH adjuster is citric acid.

25. The beverage of claim 23 wherein the pH of the beverage is about 2.0 to 4.0.

26. The beverage of claim 14 wherein the conjugated linoleic acid is substantially the only fatty acid in the composition.

27. The beverage of claim 14 wherein the beverage comprises at least one of a carbonated soft drink, non-carbonated soft drink, fountain beverage, frozen ready-to-drink beverage, coffee beverage, tea beverage, dairy beverage, powdered soft drink, liquid concentrate, flavored water, enhanced water, fruit juice, fruit-juice flavored drink, sports drink, and alcoholic beverage.
